(19) United States
(12) Patent Application Publication
(10) Pub. No.: US 2005/0243840 A1
(43) Pub. Date: Nov. 3, 2005

(54) Method of communication

(75) Inventors: Kengatharan Sivalingam, Irving, TX (US); Basavaraj Patil, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/960,567

(22) Filed: Oct. 8, 2004

Related U.S. Application Data
(60) Provisional application No. 60/566,076, filed on Apr. 29, 2004.

(51) Int. Cl. H04B 7/185

(52) U.S. Cl. 370/401

(57) ABSTRACT

A method and system that each allow for communication between a first network and a second network. The first and second networks typically operate in accordance with different protocols and a user associated with the first network is typically connected to the second network. The method includes determining when a routing entity is associated with at least one of the networks. The method also includes using a gateway for traffic when the routing entity is associated with one of the network. Further, the method includes using tunnelling for the traffic when the routing entity is associated with the other of the networks.

### FIELD OF THE INVENTION

The present invention relates to a method of communication between a first network and a second network.

### BACKGROUND OF THE INVENTION

A communication system can be seen as a facility that enables communication between two or more entities such as user equipment and/or other nodes associated with the system. The communication may comprise, for example, communication of voice, data, multi-media and so on.

A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which should be used for the connection may also be defined. In other words, a specific set of “rules” on which the communication can be based needs to be defined to enable communication by means of the system.

Communication systems providing wireless communication for user terminals or other nodes are known. An example of the wireless system is a cellular network. In cellular systems, a base transceiver station (BTS) or similar access entity serves mobile stations (MS) or similar user equipment (UE) via a wireless interface between the entities. The operation of the apparatus required for the communication can be controlled by one or several control entities. The various control entities may be interconnected. One or more gateway nodes may also be provided for connecting the network to another network, such as another cellular system or to a public switched telephone network (PSTN) and/or other communication networks such as internet protocol (IP) and/or other packet switched networks. The Session Initiation Protocol (SIP) is one of the communication protocols that can be used between user equipment and certain network elements.

Various different standards have been suggested. For example, the third generation partnership project (3GPP) is defining a reference architecture, for example the universal mobile telecommunication system (UMTS). This UMTS core network is divided into three principal domains. These are the circuit switched domain, the packet switched domain and the Internet protocol multi-media (IM) domain. The IM domain makes sure that multi-media services are adequately managed. The IP Multimedia System (IMS) currently defined by 3GPP is described as supporting the protocol IPv6 (Internet protocol version 6) as defined in the Internet Engineering Task Force IETF standard http://www.ietf.org/html.charters/ipv6-charter.html and RFCs: RFC2460, RFC2461 and RFC3513. However, there are other reference architectures for 3G networks being proposed currently. For example, there exists the third generation partnership project 2 (3GPP2). This is a collaborative third generation telecommunications specification project. It comprises North American and Asian interests developing global specifications. 3GPP2 was born out of the International Telecommunication Union's (ITU) International Mobile Telecommunications (IMT-2000) initiative. Currently, with 3GPP2 networks, they can either support IPv4 or IPv6, that is the Internet Protocol version 4 or version 6. 3GPP2 standards allow IPv4 or IPv6 to be used in cdma2000 networks. If a 3GPP user roams to an IPv4 based 3GPP2 network, it is desirable that he should be able to access his home network, i.e. the IPv6 IMS via the 3GPP2 network. Accordingly, this would involve some IPv4/IPv6 inter working.

In the document http://www.ietf.org/internet-drafts/draft-elmalki-sipping-3gpp-translator-00.txt, an IPv6-IPv4 translation mechanism for SIP based services in the third generation partnership project networks is described. This document is however concerned about the connection of a 3GPP IMS system supporting IPv6 with an IPv4 host for example on the Internet. This document does not address the issue of for example a 3GPP user accessing his home network when he roams to a network supporting a different version of the IP protocol.

It is an aim of embodiments of the present invention to address or at least mitigate the above described problems.

### SUMMARY OF THE INVENTION

According to the first aspect of the invention there is provided a method of communication between a first network and a second network, said first and second networks operating in accordance with different protocols, wherein a user associated with said first network is connected to said second network, said method comprising the steps of determining if a routing entity is associated with the first or the second network; and using a gateway for traffic if said routing entity is associated with given one of said first and second networks and tunnelling for traffic if said routing entity is associated with the other of the first and second networks.

According to a second aspect of the invention there is provided a system comprising a first network and a second network, said first and second networks operating in accordance with different protocols, wherein a user associated with said first network is connected to said second network, a routing entity in one of said networks and a gateway, wherein said gateway is used for traffic if said routing entity is associated with given one of said first and second networks and tunnelling is used for traffic if said routing entity is associated with the other of the first and second networks.

According to a third aspect of the invention there is provided a gateway between a first network and a second network, said first and second networks operating in accordance with different protocols, said gateway arranged so that when a user associated with said first network is connected to said second network, traffic associated with said user passes through said gateway, said gateway being arranged to modify said traffic.

### BRIEF DESCRIPTION OF DRAWINGS

For a better understanding of the present invention and as to how the same may be carried into effect, reference will now be made by way of example to the accompanying drawings in which:

FIG. 1 shows two networks in which embodiments of the present invention can be used;

FIG. 2 shows a signalling flow in an embodiment of the invention; and

FIG. 3 shows the roaming gateway of FIG. 1, in more detail.

### DESCRIPTION OF PREFERRED EMBODIMENTS

It will be understood that in the following description the present invention is described with reference to particular non limiting examples from which the invention can best be understood. The invention, however, is not limited to such examples.

It should be appreciated that the term “service” used in this document should be understood to broadly cover any service or goods which a user may desire, require or be provided with. The term also should be understood to cover the provision of complementary services. In particular, but not exclusively, the term service will be understood to include internet protocol multimedia services such as conferencing, voice and video telephony, gaming, rich call, presence, e-commerce and messaging.

In preferred embodiments of the present invention, a user obtains access to a network via user equipment (UE). The user equipment, in embodiments of the present invention can be moved. Accordingly, the user equipment may be a laptop or notebook computer, mobile telephone, personal data assistant, organisers, or combinations of these entities.

Embodiments of the present invention are described in the context of a 3GPP user, where the 3GPP network supports IPv6, roams to a 3GPP2 network which supports IPv4. However, it should be appreciated that the principal of embodiments of the present invention can be extended to the user of an IPv4 network roaming into an IPv6 network. Embodiments of the present invention also have broader application to any situation where a user from one network supporting one protocol roams into a different network supporting a different protocol. That protocol may be an internet protocol and different versions of that protocol. Alternatively, the protocol may be an internet protocol and a different protocol or both protocols may be different from the IP protocol.

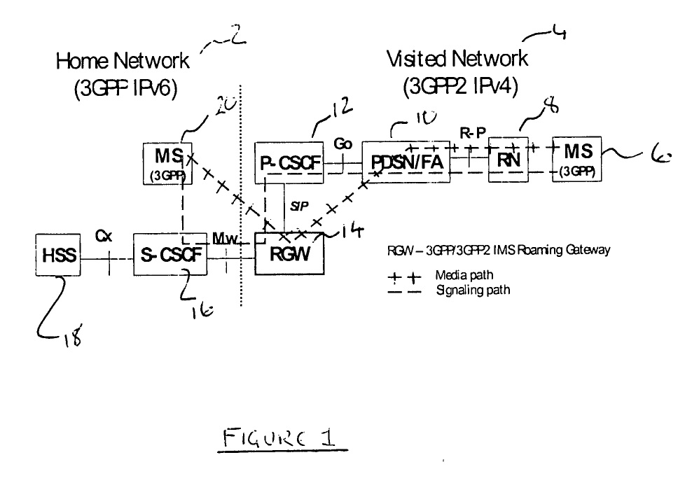

Reference will now be made to FIG. 1 which shows two networks with which embodiments of the present invention can be implemented.

FIG. 1 shows two networks 2 and 4. Network 2 is the home network of the user equipment 6. The user equipment 6 is in a visited network 4. In the embodiment shown in FIG. 1, the home network 2 is a 3GPP IPv6 network and the visited network is a 3GPP2 network.

The mobile station 6 is arranged to attach to the radio network (RN) 8. The radio network 8 comprises the radio access network. The radio network 8 may comprise a base station or similar entity. The mobile station 6 will communicate via a wireless interface with the base station. The base station may be connected to a control element similar to a radio network controller in the 3GPP standard or the base station controller of the GSM standard. Alternatively, the control function may be incorporated with a base station type element.

The radio network 8 is connected to a packet data serving node PDSN/FA (Foreign agent) 10. This element 10 is provided in a core network of the visited network 4. Also provided in the core network is a P-CSCF 12 (proxy-call state control function). Finally, also provided is a roaming gateway RGW 14. The roaming gateway 14 is a new entity proposed by embodiments of the present invention. The PDSN provides packet switched communication.

The core network of the visited network 4 may comprise a series of call state control functions (CSCFs) of which the proxy call state control function P-CSCF 12 is shown.

In embodiments of the present invention, communications from the mobile station 6 to the radio network 8 are via the wireless interface. The radio network 8 is connected to the PDSN/FA 10. The PDSN/FA is connected both to the RGW 14 and P-CSCF. The P-CSCF is connected to the RGW 14.

It should be appreciated that the media path, that is the data traffic from the mobile station goes to the radio network 8 to the PDSN/FA 10 to the RGW and vice versa. The signalling traffic (such as SIP) flows from the MS to the radio network 8 to the PDSN/FA 10 to the P-CSCF 12 and from there to RGW 14. The connection between the P-CSCF 12 and the RGW 14 may operate in accordance with the session initiation protocol SIP.

SIP is specified (in RFC 3261) by the Internet Engineering Task Force (IETF). SIP is an application layer signalling protocol for starting, changing and ending user sessions as well as for sending and receiving transactions. A session, may for example, be a two way telephone call or multi-way conference session or connection between a user and an application server (AS). The establishment of these sessions enables a user to be provided with the above mentioned services.

The relevant elements of the home network 2 will now be described. The S-CSCF (Serving-CSCF) 16 is provided which has a connection to a HSS 18 (home subscriber server). The HSS has information related to the user's subscription information such as the services for which the user is permitted to obtain. The mobile station 20 is in the 3GPP network and using SIP. The IMS session is being established between mobile station 6 that is in the 3GPP2 network and the mobile station 20 in the 3GPP network. This is accomplished as a result of the RGW 14.

The roaming gateway node provides all the necessary inter working functionalities for a 3GPP roaming user. The RGW is required only when the P-CSCF is located in the visited network. If the P-CSCF resides in the home network then a tunnelling technique can be used to carry IPv6 traffic over IPv4 from the mobile station.

In embodiments of the present invention, it is assumed that the mobile roaming user's mobile station supports the following: dual IP stack (IPv4 and IPv6). In other words, the mobile station itself is capable of supporting IPv4 and IPv6. It is also assumed that the mobile station 6 supports both the 3GPP and 3GPP2 air interfaces. Finally, it is assumed that the mobile station supports the USIM (universal subscribe identity module) requirements of the 3GPP specifications and R-UIM (removable-user identity module) required by the 3GPP2 specifications.

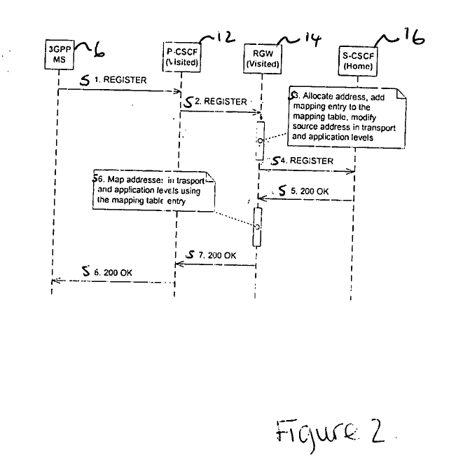

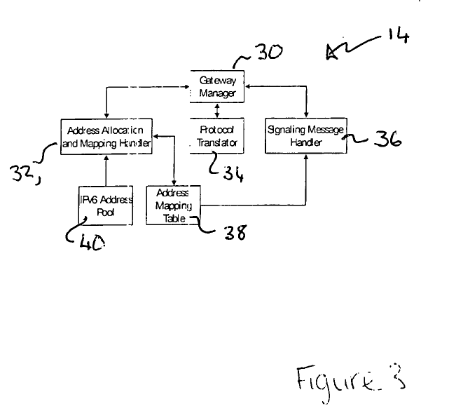

In the embodiment shown in FIG. 1 and described in relation to FIGS. 2 and 3, the scenario where a 3GPP user is roaming in a 3GPP2 network is described. However, embodiments of the present invention are equally applicable where a 3GPP 2 user is roaming in a 3GPP network.

For a 3GPP user roaming in a 3GPP2 network, the RGW has to be in the 3GPP2 network and it has to be configured with the 3GPP IMS contact information. The same is true for a 3GPP2 user roaming in a 3GPP network, the RGW would be located in the 3GPP network with equivalent configuration, ie the 3GPP2 IMS information.

Signalling and media traffic will be protocol and address translated by the RGW. Signalling and media paths are shown in FIG. 1.

Reference will now be made to FIG. 3 which shows the roaming gateway of FIG. 1 in more detail. As mentioned, the interface between the P-CSCF and the RGW uses SIP. If the roaming user initiates a message and the destination is an IPv6 address, then the message would be forwarded by the PDSN/FA to the RGW 14. Terminating messages for the roaming user will reach the RGW first in the visited network before they are modified and delivered to the mobile station 6.

The RGW 14 has a number of functional entities. There is a gateway manager 30. This is the point of entry to the roaming gateway 14. The gateway manager communicates with other internal entities in order to do address mapping, protocol translation or SIP message handling. The gateway manager is therefore connected to an address allocation and mapping handler 32, a protocol translator 34 and a signalling message handler 36. The address allocation and mapping handler is connected to an address mapping table 38. The address mapping table 38 is also connected to the signalling message handler 36. An IPv6 address pool 40 is provided which is connected again to the address allocation and mapping handler 32.

The address allocation and mapping handler 32 is arranged to pick an IPv6 address. This occurs when the user registers to the IMS. The IPv6 address is selected from the IPv6 address pool 40. The address allocation and mapping handler will then map the selected IPv6 address to the roaming user's IPv4 address. This entity is also responsible for swapping addresses back and forth in the transport layer.

The protocol translator 34 provides protocol translation between IPv4 and IPv6

The signalling message handler 36 is arranged to receive SIP signalling messages from the gateway manager 30. The source/destination address, contact address and any IP address in the SDP (session description protocol) are modified according to the mapping entry found in the mapping table 38.

When a user sends a REGISTER (SIP message), an IPv6 address is allocated and a mapping entry is added to this table. The entry is removed when the roaming user deregisters from IMS.

The RGW needs to assign the MS an IPv6 address at the RGW and create a mapping between this assigned IPv6 address and the IPv4 address of the MS. The RGW is responsible for assigning IPv6 addresses to a number of mobile stations. Additionally the IPv6 address is released at the expiry of the SIP Registration lifetime. The IPv6 address assigned to an MS at the RGW is transient and hence it is drawn from a pool of IPv6 addresses. DHCPv6 (Dynamic Host Configuration Protocol) is a solution for managing a pool of IPv6 addresses. A lease period is assigned to each IPv6 address that is allocated to a MS by the RGW. This lease period would be equivalent of the SIP Registration lifetime. The address would be returned to the pool (for use by another MS) at the end of the lease period if it is not renewed. Hence DHCPv6 is one possible means of managing the IPv6 address pool. Note that the RGW could implement a proprietary scheme wherein it could manage its own IPv6 address pool without using a standardized solution like DHCPv6.

Reference is now made to FIG. 2 which illustrates the signalling flow during IMS registration using the RGW 14.

When the user wants to register to his home IMS, the mobile station 6 sends in step S1 a REGISTER message to the P-CSCF 12. The IPv4 P-CSCF in the visited network will forward the message to the RGW 14 since it does not know how to handle an IPv6 destination address. Thus, in step S2, the REGISTER message is forwarded by the P-CSCF 12 to the RGW 14. In step S3, the RGW 14 allocates an address from the IPv6 address pool, i.e. an IPv6 address and maps it to the mobile station's IPv4 address. The mapping will be added as a mapping entry to the mapping table. The source and contact addresses of the REGISTER message are now modified to the mapped IPv6 address in the transport and application levels.

In step S4, the modified register message is sent to the S-CSCF 16 in the user's home network. The S-CSCF 16 sends in step S5 a 200 OK message to the RGW 14. 200 OK is an SIP message and effectively is an acknowledgement. In step S6, the RGW will map the IPv6 address used in the 200 OK message received from the S-CSCF 16 to obtain the corresponding IPv4 address. This is done using the mapping table entry and is done on the transport and application levels. Thus, in step S7 a modified 200 OK message is sent from the RGW 14 to the P-CSCF 12. In other words, the address information in the 200 OK message now contains the corresponding IPv4 address.

In step S8 a 200 OK message is sent from P-CSCF 12 to the 3GPP mobile station. This is the same as the message sent in step S7.

It should be appreciated that all SIP messages will be handled by the RGW in a similar way. Thus, SIP messages such as INVITE, 200 OK, REGISTER etc. which contain IP addresses will be modified by the gateway. If the message is going from the mobile station to its home network, the IPv6 address will be substituted for the IPv4 address. On the other hand, if the message is coming from the mobile station, the IPv4 address will be substituted by the IPv6 address.

Embodiments of the present invention are advantageous in that it does not impose any new requirements and new protocols on the mobile terminals. Thus, no new protocols need to be standardised.

1. A method of communication between a first network and a second network, said first and second networks operating in accordance with different protocols, wherein a user associated with said first network is connected to said second network, said method comprising the steps of:
determining when a routing entity is associated with at least one of the first and the second network;
using a gateway for traffic when said routing entity is associated with a given one of said first and second networks; and
using tunnelling for said traffic when said routing entity is associated with another of the first and second networks.

2. The method as claimed in claim 1, wherein, in said using a gateway step, said gateway is used when said routing entity is associated with said second network.

3. The method as claimed in claim 1, further comprising the step of modifying at least one of traffic to a user in said gateway and traffic from said user in said gateway.

4. The method as claimed in claim 3, wherein said modifying step comprises the step of modifying address information contained in said traffic.

5. The method as claimed claim 1, further comprising the step of allocating, in said gateway, an address usable in said first network.

6. The method as claimed in claim 5, further comprising the step of de-allocating said address when a user is disconnected from said first network.

7. The method as claimed in claim 1, further comprising the step of mapping, in said gateway, an address usable in said first network with an address usable in said second network.

8. The method as claimed in claim 1, further comprising the step of using SIP for messages sent between said routing entity and said gateway.

9. The method as claimed in claim 1, wherein said routing entity comprises a proxy entity.

10. The method as claimed in claim 1, wherein said routing entity comprises a call session control function.

11. The method as claimed in claim 1, wherein said different protocols comprise different versions of a same protocol.

12. The method as claimed in claim 1, wherein said different protocols comprise at least one of IPv6 and IPv4.

13. The method as claimed in claim 1, wherein said first and second networks comprise wireless communication networks.

14. The method as claimed in claim 1, wherein at least one of said first and second networks is in accordance with at least one of 3GPP specifications and 3GPP2 specifications.

15. A system comprising a first network and a second network, said first and second networks operating in accordance with different protocols, wherein a user associated with said first network is connected to said second network, a routing entity in one of said first and second networks, and a gateway, wherein said gateway is used for traffic when said routing entity is associated with a given one of said first and second networks, and wherein tunnelling is used for said traffic when said routing entity is associated with another of the first and second networks.

16. The system as claimed in claim 15, wherein said gateway is used when said routing entity is associated with said second network.

17. The system as claimed in claim 15, wherein said gateway is arranged to modify at least one of a first traffic to said user and a second traffic from said user.

18. The system as claimed in claim 17, wherein said gateway is arranged to modify address information contained in said at least one of said first and second traffic.

19. The system as claimed in claim 15, wherein said gateway is arranged to allocate an address usable in said first network.

20. The system as claimed in claim 19, wherein the gateway is arranged to de-allocate said address when the user is disconnected from said first network.

21. The system as claimed in claim 15, wherein the gateway is arranged to map an address usable in said first network with an address usable in said second network.

22. The system as claimed in claim 15, wherein said routing entity and said gateway are arranged to use SIP for messages sent therebetween.

23. The system as claimed in claim 15, wherein said routing entity comprises a proxy entity.

24. The system as claimed in claim 15, wherein said routing entity comprises a call session control function.

25. The system as claimed in claim 15, wherein said different protocols comprise different versions of the same protocol.

26. The system as claimed in claim 15, wherein said different protocols comprise at least one of IPv6 and IPv4.

27. The system as claimed in claim 15, wherein said first and second networks comprise wireless communication networks.

28. The system as claimed in claim 15, wherein at least one of said first and second networks is in accordance with at least one of 3GPP specifications and 3GPP2 specifications.

29. A gateway between a first network and a second network, said first and second networks operating in accordance with different protocols, said gateway arranged so that, when a user associated with said first network is connected to said second network, traffic associated with said user passes through said gateway, said gateway being arranged to modify said traffic.

30. The gateway as claimed in claim 29, wherein said gateway is arranged to modify address information contained in said traffic.

31. The gateway as claimed in claim 29, wherein said gateway is arranged to allocate an address usable in said first network.

32. The gateway as claimed in claim 31, wherein the gateway is arranged to de-allocate said address when the user is disconnected from said first network.

33. The gateway as claimed in claim 29, wherein the gateway is arranged to map said address usable in said first network with an address usable in said second network.

34. A communication system between a first network and a second network, said first and second networks operating in accordance with different protocols, wherein a user associated with said first network is connected to said second network, said system comprising:
determining means for determining when a routing entity is associated with at least one of the first and the second network;
control means, operably connected to said determining means, for using a gateway for traffic when said routing entity is associated with a given one of said first and second networks; and
tunneling means for tunneling for said traffic when said routing entity is associated with another of the first and second network.

35. A gateway between a first network and a second network, said first and second networks operating in accordance with different protocols, said gateway comprising:
communications means for passing traffic associated with a user through a gateway when said user is associated with a first network and is connected to a second network; and
modifying means, operably connected to said communication means, for modifying said traffic.
